(19) United States
(12) Patent Application Publication
(10) Pub. No.: US 2025/0315655 A1
(43) Pub. Date: Oct. 9, 2025

(54) METHOD FOR OPERATING ADAPTIVE TRANSFORMER, METHOD FOR TRAINING THE SAME, AND COMPUTING DEVICE INCLUDING THE SAME

(71) Applicant: SAMSUNG SDS CO., LTD., Seoul (KR)

(72) Inventors: Jin Ho CHOO, Seoul (KR); Yeong Dae KWON, Seoul (KR); Suk Hoon JUNG, Seoul (KR)

(73) Assignee: SAMSUNG SDS CO., LTD., Seoul (KR)

(21) Appl. No.: 19/076,529

(22) Filed: Mar. 11, 2025

(30) Foreign Application Priority Data
Apr. 3, 2024 (KR) 10-2024-0045013
Aug. 1, 2024 (KR) 10-2024-0102290

(51) Int. Cl. G06N 3/0455; G06N 3/048; G06N 3/092

(52) U.S. Cl. CPC G06N 3/0455; G06N 3/048; G06N 3/092

(57) ABSTRACT

A method for operating an adaptive transformer may comprise: inputting a first input token and a first position encoding corresponding to the first input token to a first model to generate a first attention module output; determining whether to perform an additional computation on the first input token, based on the first attention module output; upon determination that the additional computation is to be performed on the first input token, determining a second input token based on the first input token and the first attention module output; determining a second position encoding corresponding to the second input token; inputting the second input token and the second position encoding to the first model to generate a second attention module output; and upon determination that the additional computation is not to be performed on the first input token, generating a final output token based on the first attention module output.

### CROSS-REFERENCE TO RELATED APPLICATIONS

This application claims priority from Korean Patent Application No. 10-2024-0045013 filed on Apr. 3, 2024 and 10-2024-0102290 filed on Aug. 1, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a method for operating an adaptive transformer, a method for training the same, and a computing device including the same, and more particularly, to a method for operating an adaptive transformer and a method for training the same which may variably adjust the number of times of computations on an input token to optimize an amount of computation by

### Description of Related Art

A general transformer performs a computation according to a fixed neural network structure and then outputs a computation result. That is, the same amount of computation is performed on all input tokens to output an output token regardless of whether the input is simple or complicated. In this regard, since an amount of inference computation increases according to the number of parameters of the model, there is a problem in that the amount of inference computation increases when the number of parameters of the model is increased to increase accuracy.

To solve this problem, a scheme of skipping an attention computation in the transformer has been proposed. However, after the skipping, the key and value of the transformer may be omitted, or a batch computation may be impossible. In addition, a scheme of delaying the output in the transformer and performing the computation two or more times has also been proposed. However, in this scheme, even when the input is simple and thus it suffices that a computation is performed thereon only once, the computation is performed thereon twice or more. Thus, the number of times of the additional computation is not variable.

### SUMMARY

A technical purpose to be achieved through embodiments of the present disclosure is to provide a method for variably adjusting the number of times of computations on each input token of a transformer to optimize an amount of computation of the transformer.

In addition, a technical purpose to be achieved through embodiments of the present disclosure is to provide a method for generating a new input token and a position encoding to be used as an input to an additional computation when it is determined that the additional computation is to be performed on an input token.

Furthermore, a technical purpose to be achieved through embodiments of the present disclosure is to provide a method for training a model for determining whether to perform an additional computation on an input token.

The technical purposes of the present disclosure are not limited to the technical purposes mentioned above, and other technical purposes not mentioned may be clearly understood by those skilled in the art from the following description.

A method for operating an adaptive transformer according to one embodiment of the present disclosure may be performed by a computing device. The method may comprise: inputting a first input token and a first position encoding corresponding to the first input token to a first model to generate a first attention module output; determining whether to perform an additional computation on the first input token, based on the first attention module output; upon determination that the additional computation is to be performed on the first input token, determining a second input token based on the first input token and the first attention module output; determining a second position encoding corresponding to the second input token; inputting the second input token and the second position encoding to the first model to generate a second attention module output; and upon determination that the additional computation is not to be performed on the first input token, generating a final output token based on the first attention module output.

In one embodiment, the determining of whether to perform the additional computation may include: inputting the first attention module output to a second model to determine whether to perform an additional computation on the first input token, wherein the second model is an artificial neural network model trained using reinforcement learning (RL).

In one embodiment, the determining of whether to perform the additional computation may include: calculating a softmax probability distribution corresponding to the first attention module output; and based on that a maximum value of the softmax probability distribution is smaller than or equal to a predetermined threshold value, determining that the additional computation is to be performed on the first input token.

In one embodiment, the determining of whether to perform the additional computation may include: calculating a softmax probability distribution corresponding to the first attention module output; and based on that an entropy of the softmax probability distribution is equal to or greater than a predetermined threshold value, determining that the additional computation is to be performed on the first input token.

In one embodiment, the determining of whether to perform the additional computation may include: calculating a confidence score corresponding to the first attention module output; and based on that the confidence score is smaller than or equal to a preset threshold value, determining that the additional computation is to be performed on the first input token.

In one embodiment, the determining of the second input token may include determining the first input token as the second input token.

In one embodiment, the determining of the second input token may include determining the first attention module output as the second input token.

In one embodiment, the determining of the second input token may include determining a special token related to the first model as the second input token.

In one embodiment, the determining of the second input token may further include determining a trainable parameter related to the special token as the second input token.

In one embodiment, the determining of the second input token may include determining a sum of at least two of the first input token, the first attention module output, and a special token related to the first model as the second input token.

In one embodiment, the determining of the second position encoding may include: determining the second position encoding via one-dimensional position embedding based on position information of the first input token and a number of times the additional computation is performed on the first input token.

In one embodiment, the determining of the second position encoding may include: determining the second position encoding via two-dimensional position embedding based on a two-dimensional vector having, as components thereof, position information of the first input token and a number of times the additional computation is performed on the first input token.

In one embodiment, the determining of the second position encoding may include: determining the second position encoding via a first one-dimensional position embedding based on the position information of the first input token, and a second one-dimensional position embedding based on a number of times the additional computation is performed on the first input token.

A method for training an adaptive transformer according to another embodiment of the present disclosure may be performed by a computing device. The method may comprise: inputting a first input token sequence including a plurality of input tokens to a first model to generate a first plurality of attention module outputs corresponding to the plurality of input tokens; inputting the plurality of first attention module outputs to a second model to determine whether to perform an additional computation on each of the plurality of input tokens; upon determination that an additional computation is to be performed on a first input token among the plurality of input tokens, adding a second input token behind the first input token to generate a second input token sequence; inputting the second input token sequence to the first model to generate a plurality of second attention module outputs corresponding to the plurality of input tokens and the second input token; calculating a compensation of the second model resulting from the determination that the additional computation is to be performed on the first input token; and updating a parameter of the second model, based on a result of determining whether to perform the additional computation and the compensation.

In one embodiment, the calculating of the compensation of the second model may include: calculating, as the compensation of the second model, a difference between a gain resulting from the determination that the additional computation is to be performed on the first input token and a preset threshold value.

In one embodiment, the gain may be calculated as a difference between a first probability corresponding to a final output token generated based on the first plurality of attention module outputs and a second probability corresponding to a final output token generated based on the second plurality of attention module outputs.

In one embodiment, the gain may be calculated as a ratio of a second probability corresponding to a final output token generated based on the second plurality of attention module outputs to a first probability corresponding to a final output token generated based on the first plurality of attention module outputs.

A computing device according to still another embodiments of the present disclosure may comprise: a processor; and a memory for storing therein instructions, wherein when the instructions are executed by the processor, the instructions may cause the processor to: input a first input token and a first position encoding corresponding to the first input token to a first model to generate a first attention module output; determine whether to perform an additional computation on the first input token, based on the first attention module output; upon determination that the additional computation is to be performed on the first input token, determine a second input token based on the first input token and the first attention module output; determine a second position encoding corresponding to the second input token; input the second input token and the second position encoding to the first model to generate a second attention module output; and upon determination that the additional computation is not to be performed on the first input token, generate a final output token based on the first attention module output.

In one embodiment, the determining of whether to perform the additional computation may include: inputting the first attention module output to a second model to determine whether to perform an additional computation on the first input token, wherein the second model is an artificial neural network model trained using reinforcement learning (RL).

A computing device according to still another embodiments of the present disclosure may comprise: a processor; and a memory for storing therein instructions, wherein when the instructions are executed by the processor, the instructions may cause the processor to: input a first input token sequence including a plurality of input tokens to a first model to generate a first plurality of attention module outputs corresponding to the plurality of input tokens; input the plurality of first attention module outputs to a second model to determine whether to perform an additional computation on each of the plurality of input tokens; upon determination that an additional computation is to be performed on a first input token among the plurality of input tokens, add a second input token behind the first input token to generate a second input token sequence; input the second input token sequence to the first model to generate a plurality of second attention module outputs corresponding to the plurality of input tokens and the second input token; calculate a compensation of the second model resulting from the determination that the additional computation is to be performed on the first input token; and update a parameter of the second model, based on a result of determining whether to perform the additional computation and the compensation.

Specific details of other embodiments are included in the detailed description and drawings.

### BRIEF DESCRIPTION OF DRAWINGS

The above and other aspects and features of the present disclosure will become more apparent by describing in detail embodiments thereof with reference to the attached drawings, in which:

FIG. 1 is a block diagram illustrating an example configuration of an entire system according to an embodiment of the disclosure;

FIG. 2 is a block diagram illustrating an example configuration of an adaptive transformer according to an embodiment of the present disclosure;

FIG. 3 conceptually illustrates an example operation of an adaptive transformer according to an embodiment of the present disclosure;

FIG. 4 is a block diagram illustrating an example configuration of an adaptive transformer according to another embodiment of the present disclosure;

FIG. 5 is an example flowchart illustrating a method for operating an adaptive transformer according to an embodiment;

FIG. 6 is a flowchart illustrating an embodiment of an operation of determining whether to perform an additional computation of FIG. 5;

FIG. 7 is a flowchart illustrating another embodiment of an operation of determining whether to perform an additional computation of FIG. 5;

FIG. 8 is a flowchart illustrating still another embodiment of an operation of determining whether to perform an additional computation of FIG. 5;

FIG. 9 is a block diagram illustrating a configuration for training of an adaptive transformer according to an embodiment of the present disclosure;

FIG. 10 is an example code for training of an adaptive transformer according to an embodiment of the present disclosure;

FIG. 11 shows an example of each of an input token sequence and an extended input token sequence of FIG. 10;

FIG. 12 is an example flowchart illustrating a method for training an adaptive transformer according to an embodiment of the present disclosure; and

FIG. 13 is a block diagram illustrating a hardware configuration of a computing device including an adaptive transformer according to an embodiment of the present disclosure.

### DETAILED DESCRIPTIONS

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

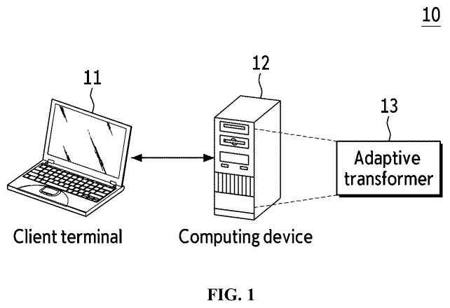

FIG. 1 is a block diagram illustrating an example configuration of an entire system 10 according to an embodiment of the present disclosure. Referring to FIG. 1, the entire system 10 may include a client terminal 11 and a computing device 12. In addition, the computing device 12 according to an embodiment of the present disclosure may include an adaptive transformer 13. For example, the adaptive transformer 13 may be a portion of an artificial intelligence model.

For reference, a model of the present disclosure refers to a neural network model that has a universal understanding ability of a language (or natural language/text) by learning a vast amount of texts (e.g., texts of various domains). The model of the present disclosure may include a large-scale model having query and response capability based on a text interface, or may include a model capable of ‘generating’ a response to a query. Thus, the model may be named as a ‘largescale language model (LLM)’, a ‘generative AI model’, a ‘query-response model’, a ‘interactive model’, or the like in some cases.

The client terminal 11 is a terminal which communicate with the computing device 12 and is used by a user to perform a specific task by utilizing an artificial intelligence model including the adaptive transformer 13. For example, the user may input a prompt for performing a specific task to the artificial intelligence model of the computing device 12 through the client terminal 100. In addition, the artificial intelligence model may divide the input prompt into input tokens and input the input tokens to the adaptive transformer 12. For example, the client terminal 11 may include a smart phone, a tablet PC, a laptop, and the like. However, the present disclosure is not limited thereto, and the client terminal 11 may include all kinds of computing devices including a computation means and a communication means.

The computing device 12 may input the input token to the adaptive transformer 13 to generate an attention module output, and generate an output token based on the attention module output. In particular, the adaptive transformer 13 according to an embodiment of the disclosure may variably adjust the number of times of computations based on a result of determining whether to perform an additional computation on the input token. For example, the adaptive transformer 13 may input the attention module output corresponding to the input token to a reinforcement learning (RL) model to determine whether to perform the additional computation on the input token. In addition, the computing device 12 may perform an operation of training the reinforcement learning model for determining whether to perform the above-described additional computation.

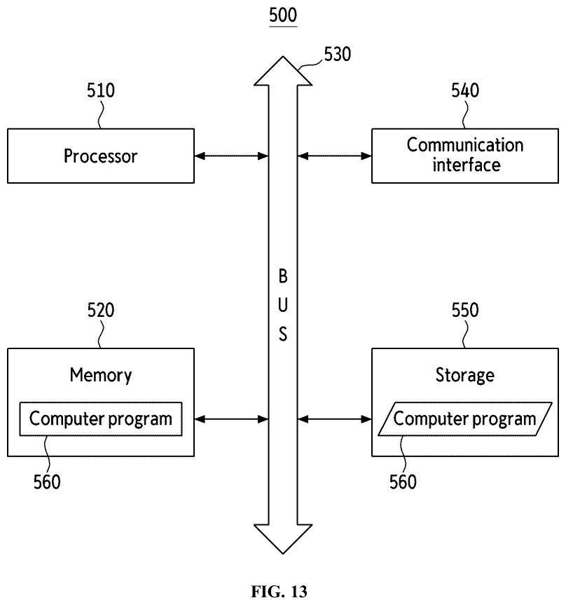

The computing device 12 may be configured using one or more physical servers included in a server farm based on cloud technology such as a virtual machine. A detailed configuration and operation of the computing device 12 according to an embodiment of the present disclosure will be described later with reference to FIG. 13.

The components illustrated in FIG. 1 may communicate with each other over a network. For example, the network may be embodied as any kind of wired/wireless network such as a Local Area Network (LAN), a Wide Area Network (WAN), a mobile radio communication network, a wireless broadband Internet (Wibro), and the like.

Hereinafter, embodiments in which the adaptive transformer 13 determines whether to perform an additional computation on the input token and embodiments in which the reinforcement learning model for determining whether to perform the additional computation is trained will be reviewed.

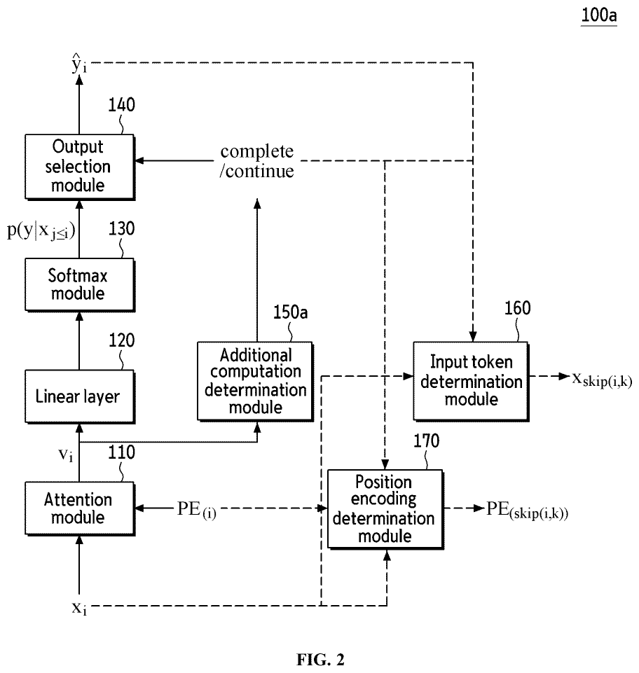

FIG. 2 is a block diagram illustrating an example configuration of an adaptive transformer 100a according to an embodiment of the present disclosure. Referring to FIG. 2, the adaptive transformer 100a may include an attention module 110, a linear layer 120, a softmax module 130, an output selection module 140, an additional computation determination module 150a, an input token determination module 160, and a position encoding determination module 170. In one example, the components (modules) illustrated in FIG. 2 represent functional elements that are functionally distinguished from each other, and it is noted that at least one component (module) may be implemented in a form in which they are integrated with each other in an actual physical environment.

The adaptive transformer 100a may be a portion of an artificial intelligence model (e.g., a large language model). The artificial intelligence model may receive a series of prompts from the user, and may divide the prompts into a plurality of input tokens xᵢ. For example, the input token xᵢ may correspond to individual words constituting the prompt.

The attention module 110 may receive the input token xᵢ and the position encoding PE₍ᵢ₎ corresponding to the input token xᵢ and generate an attention module output vᵢ. The attention module 110 may include a plurality of attention blocks, and each attention block may include an attention layer and a feed-forward layer for decoding the input token xᵢ. Basically, the number of times of computations on the input token xᵢ may be determined based on the number of attention blocks. However, according to an embodiment of the disclosure, the number of times of computations on the input token xᵢ may be additionally determined according to an operation of the additional computation determination module 150a to be described later.

The linear layer 120 map the attention module outputs vᵢ so as to have a similar characteristic distribution. In some cases, the linear layer may be referred to as an output head. In addition, the softmax module 130 may calculate a softmax probability distribution p(y|xj≤i) corresponding to the attention module output vᵢ mapped via the linear layer 120. Thereafter, the output selection module 140 may receive the softmax probability distribution p (y|xj≤i) and generate a final output token ŷᵢ. A set of final output tokens ŷᵢ generated in this way may correspond to the response of the artificial intelligence model to the prompt.

The additional computation determination module 150a may determine whether to perform an additional computation on the input token xᵢ corresponding to the attention module output vᵢ based on the attention module output vᵢ. For example, the additional computation determination module 150a may be implemented to include an artificial neural network model that may be trained using reinforcement learning (RL). In this regard, the additional computation determination module 150a may output whether to continue the additional computation on the input token xi on the attention module output vᵢ using an exploration-utilization strategy or to complete the computation without performing the additional computation. The reinforcement learning model for determining whether to perform the additional computation may be trained to output an appropriate result based on the type of the input token, the type of the task the user wants to perform, a configuration of the adaptive transformer, a configuration of the artificial intelligence model including the adaptive transformer, etc.

Upon determination that the computation is completed without performing an additional computation on the input token xᵢ, the final output token ŷᵢ corresponding to the input token xᵢ may be generated through the linear layer 120, the softmax module 130, and the output selection module 140 as described above. On the other hand, when it is determined that the additional computation is continuously performed on the input token xᵢ, a new input token x_{skip(i,k)} and position encoding PE_{(skip(i,k)} to be re-input to the attention module 110 may be determined by the input token determination module 160 and the position encoding determination module 170, respectively. For reference, in FIG. 2, a portion indicated by a solid line corresponds to an operation related to a computation performed on a current input token, and a portion indicated by a dotted line corresponds to an operation related to determination of a next input token.

The input token determination module 160 may determine a new input token x_{skip(i,k)}, based on the input token xᵢ and the attention module output vᵢ, in response to the output of the additional computation determination module 150a being the additional computation being determined to be performed (continue). In this regard, the index i may indicate position information, may correspond to the index i of the input token xᵢ on which the additional computation is determined to be performed, and the index k may indicate the number of additional computations.

In some embodiments, the input token determination module 160 may determine the pre-input input token xᵢ as the new input token x_{skip(i,k)}. In some further embodiments, the input token determination module 160 may determine the pre-output attention module output vᵢ as the new input token x_{skip(i,k)}.

In some still further embodiments, the input token determination module 160 may determine a special token related to the attention module 110 as the new input token x_{skip(i,k)}. For example, the special token may be a special token added when the transformer encodes the token, such as a token (bos_token) indicating the beginning of a sentence, a token (eos_token) indicating the end of a sentence, and a token (sep_token) indicating separation between a sentence and a sentence. Furthermore, the input token determination module 160 may determine a trainable parameter related to the special token as the new input token x_{skip(i,k)}.

In some still further embodiments, the input token determination module 160 may determine a sum of at least two of the pre-input input token xᵢ, the pre-output attention module output vᵢ, and the special token as the new input token x_{skip(i,k)}. In other words, one of the sum of the input token xᵢ and the attention module output vᵢ, the sum of the input token xᵢ and the special token, the sum of the attention module output vᵢ and the special token, and the sum of the input token xᵢ, the attention module output vᵢ, and the special token may be determined as the new input token x_{skip(i,k)}. In some cases, the sum may be a weighted sum thereof. In this regard, preset weights may be allocated to the input token xᵢ, the attention module output vᵢ, and the special token, respectively.

In still some further embodiments, the input token determination module 160 may be embodied as a separate artificial intelligence model which is configured to receive at least one of the pre-input input token xᵢ, the pre-output attention module output vᵢ, the special token, or the sum of at least two of the pre-input input token xᵢ, the pre-output attention module output vᵢ, and the special token and to generate the new input token x_{skip(i,k)}.

In one example, in some embodiments, the input token determination module 160 may determine a final output ŷᵢ as a next input token xᵢ₊₁ in response to the output of the additional computation determination module 150a being the computation being determined to be completed (complete).

In response to the output of the additional computation determination module 150a being the additional computation being determined to be performed (continue), the position encoding determination module 170 may determine a new position encoding PE_{(skip(i,k))} based on the pre-input input token xᵢ and the position encoding PE₍ᵢ₎. The position encoding may be determined based on position embedding having various dimensions.

In some embodiments, the position encoding determination module 170 may determine the new position encoding PE_{(skip(i, k))} via one-dimensional position embedding based on the position information i of the pre-input input token xᵢ and the number k of times of additional computations determined on the input token xᵢ. Specifically, the position encoding PE_{(skip (i,k))} on the position information i of the pre-input input token xᵢ and the number k of times of additional computations determined on the input token xᵢ may be determined in the same manner as a manner in which PE(i+μk) may be. In this regard, μ corresponds to a hyperparameter that is a real number including 0.

In some further embodiments, the position encoding determination module 170 may determine the new position encoding PE_{(skip(i,k))} via two-dimensional position embedding based on a two-dimensional vector having the position information i of the pre-input input token xᵢ and the number of additional computations k determined on the input token xᵢ as components thereof.

In some still further embodiments, the position encoding determination module 170 may individually apply a predetermined algorithm to the one-dimensional position embedding based on the position information i of the pre-input input token xᵢ and to the one-dimensional position embedding based on the number k of times of additional computations determined on the input token xᵢ and may determine the new position encoding PE_{(skip(i,k)} as a sum of the individual application results.

When the additional computation determination module 150a determines to perform the additional computation on the input token xᵢ (continue), the generation of the final output token from the output selection module 140 may be suspended, or an invalid output token ŷₛₖᵢₚ may be output. In this regard, the invalid output token ŷₛₖᵢₚ is not included in the sequence of the final output token, and only the valid final output token ŷᵢ will be included in the sequence of the final output token.

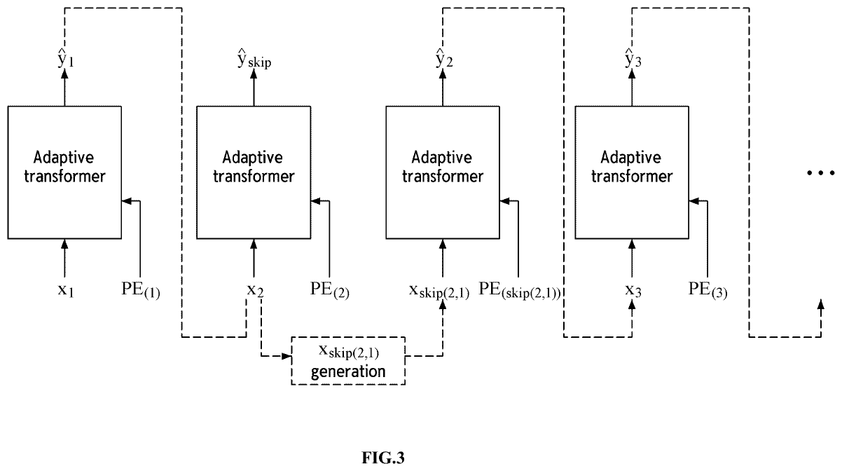

FIG. 3 conceptually illustrates an example operation of an adaptive transformer according to an embodiment of the present disclosure. Referring to FIG. 3, the transformer may receive a first input token x₁ and a corresponding position encoding PE₍₁₎, perform one computation thereon, and then immediately output a corresponding output token ŷ₁ without a further computation (complete). The output token ŷ₁ may be determined to be the next input token x₂.

Thereafter, the transformer may receive the second input token x₂ and a corresponding position encoding PE₍₂₎ and perform one computation thereon. In this regard, when an additional computation is determined to be performed on the input token x₂ (continue), the transformer may output the invalid output token ŷₛₖᵢₚ, and may determine the input token x_{skip (2,1)} and a corresponding position encoding PE_{(skip(2,1))} to be subjected to an additional computation, based on the input token x₂.

The transformer may receive the newly determined input token x_{skip(2,1)} and position encoding PE_{(skip (2,1)} and perform an additional computation thereon, and may output an output token ŷ₂ without the additional computation. The output token ŷ₂ may be determined as a next input token x₃. When all computations performed in this way are terminated, the transformer may sequentially connect the final output tokens ŷ₁, ŷ₂, . . . , ŷₙ excluding the invalid ŷₛₖᵢₚ among the output tokens to construct the sequence of the final output tokens.

In one example, although FIG. 3 illustrates that only one additional computation is performed on the input token x₂. However, the present disclosure is not limited thereto. When it is determined that the additional computation is to be performed on the input token x_{skip(2,1)}, an input token x_{skip(2,2)} and a corresponding position encoding PE_{(skip(2,2)} to be subjected to the additional computation will be determined.

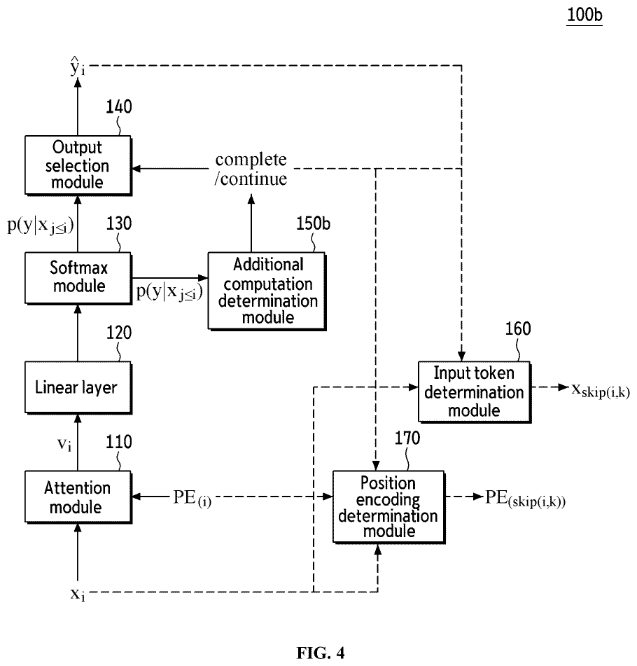

FIG. 4 is a block diagram illustrating an example configuration of an adaptive transformer 100b according to another embodiment of the present disclosure. Unlike the additional computation determination module 150a of FIG. 2, in the adaptive transformer 100b, an additional computation determination module 150b may receive a softmax probability distribution p(y|xj≤i) from the softmax module 130 instead of immediately receiving the attention module output vi from the attention module 110 and determine whether to perform an additional computation on the input token xᵢ, based on the softmax probability distribution. Since the configuration and operation of the adaptive transformer 100b except for the additional computation determination module 150b are the same as the configuration and operation of the adaptive transformer 100a as described with reference to FIG. 2, redundant descriptions will be omitted.

In some embodiments, when a maximum value of the softmax probability distribution p(y|xj≤i) is smaller than or equal to a preset threshold value, the additional computation determination module 150b may determine to perform an additional computation on the input token xᵢ. In some further embodiments, the additional computation determination module 150b may determine to perform an additional computation on the input token xᵢ when the entropy of the softmax probability distribution p(y|xj≤i) is equal to or greater than a preset threshold value.

In some further embodiments, instead of using the softmax probability distribution p(y|xj≤i), the additional computation determination module 150b may calculate a confidence score corresponding to the attention module output vᵢ, and may determine to perform an additional computation on the input token xᵢ when the confidence score is smaller than or equal to a preset threshold.

In one example, although the additional computation determination module 150a of FIG. 2 and the additional computation determination module 150b of FIG. 4 have been separately described, the present disclosure is not limited thereto. In some embodiments, whether to perform an additional computation on the input token xᵢ may be determined based on both the attention module output vi and the softmax probability distribution p(y|xj≤i) corresponding to the attention module output vᵢ.

As described with reference to FIGS. 2 to 4, the adaptive transformer according to an embodiment of the disclosure may not perform the same number of computations on the respective input tokens, but may vary the number of times of computations on each input token to optimize an amount of computation of the artificial intelligence model. In addition, as the additional computation is performed on some input tokens, the accuracy and performance of the artificial intelligence model may be improved.

For example, it is assumed that the attention module of the adaptive transformer includes N attention blocks. If there is no process of determining whether to perform an additional computation on the input token, N attention computations will be performed on each of all input tokens. However, according to an embodiment of the disclosure, N times of attention computations are performed on an input token determined not to perform an additional computation thereon, and at least (N+1) times of attention computations are performed on an input token determined to perform an additional computation thereon, thereby increasing the accuracy of the computation.

In addition, the attention module may include M attention blocks (M being smaller than N). However, in this case, as an additional computation is performed on some input tokens, the overall accuracy of the computations may reach a level similar to that as achieved when the attention module includes N attention blocks.

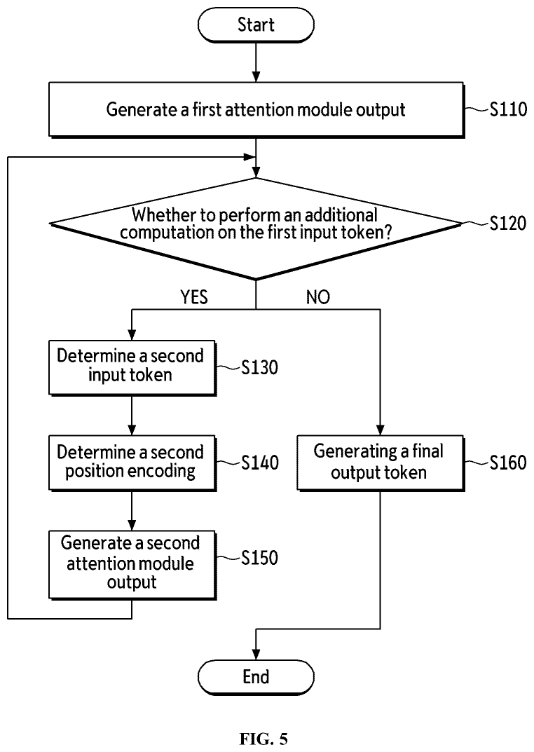

FIG. 5 is an example flowchart illustrating a method for operating an adaptive transformer according to an embodiment. For reference, FIG. 5 and FIGS. 6 to 8 and 12, which will be described later, show steps/operations performed in the computing device 12 of FIG. 1 or the computing device 500 of FIG. 13. Accordingly, in the following descriptions, it may be understood that when a subject of a specific step/operation is omitted, the corresponding step/operation is performed in the computing device 12 of FIG. 1 or the computing device 500 of FIG. 13.

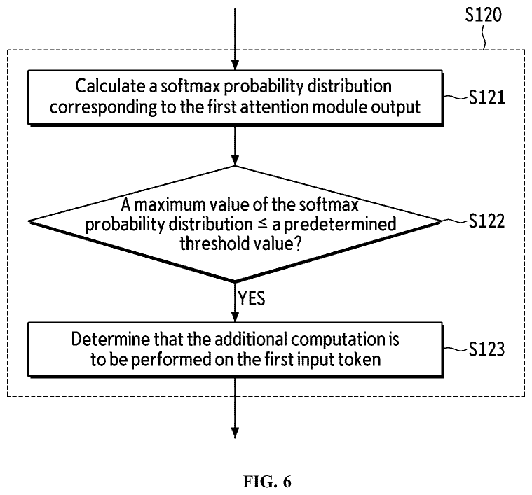

In operation S110, the first input token xi and the first position encoding PE₍ᵢ₎ corresponding to the first input token may be input to the first model, and the first attention module output vᵢ may be generated. In this regard, the first model may correspond to the attention module 110 of FIGS. 2 and 4. In operation S120, it may be determined whether to perform an additional computation on the first input token xᵢ, based on the first attention module output vᵢ. For example, the first attention module output vᵢ may be input to the reinforcement learning model, and whether to continue performing an additional computation or to complete the additional computation without the additional computation may be output therefrom. In addition to the method of using the reinforcement learning, embodiments related to operation S120 will be described with reference to FIGS. 6 to 8.

FIG. 6 is a flowchart illustrating an embodiment of the operation S120 of determining whether to perform an additional computation of FIG. 5. Referring to FIG. 6, in operation S121, a softmax probability distribution corresponding to the first attention module output vᵢ may be calculated. In operation S122, it may be determined whether the maximum value of the softmax probability distribution is smaller than or equal to a preset threshold value. When the maximum value is smaller than or equal to the threshold value (YES), it may be determined that an additional computation is to be performed on the first input token xᵢ in operation S123.

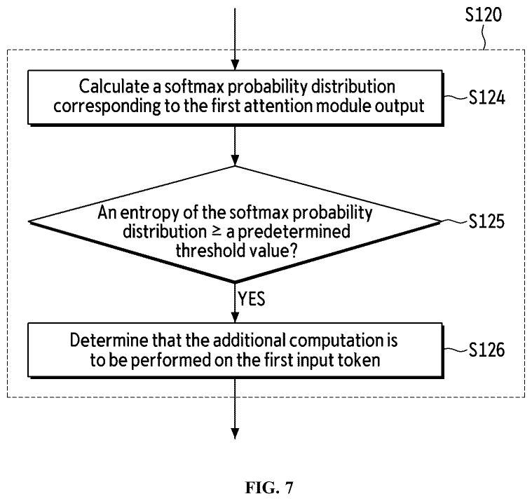

FIG. 7 is a flowchart illustrating another embodiment of the operation S120 of determining whether to perform an additional computation of FIG. 5. Referring to FIG. 7, in operation S124, a softmax probability distribution corresponding to the first attention module output vᵢ may be calculated. In operation S125, it may be determined whether the entropy of the softmax probability distribution is equal to or greater than a preset threshold value. When the entropy is equal to or greater than the threshold value (YES), it may be determined that an additional computation is to be performed on the first input token xᵢ in operation S126.

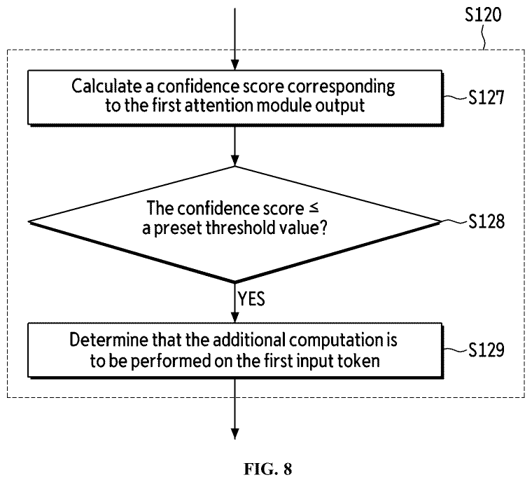

FIG. 8 is a flowchart illustrating still another embodiment of the operation S120 of determining whether to perform the additional computation of FIG. 5. Referring to FIG. 8, in operation S127, a confidence score corresponding to the first attention module output vᵢ may be calculated. In operation S128, it may be determined whether the confidence score is smaller than or equal to a preset threshold. When the confidence score is smaller than or equal to the threshold value (YES), it may be determined that an additional computation is to be performed on the first input token xᵢ in operation S129.

Referring back to FIG. 5, when it is determined that an additional computation is to be performed on the first input token xᵢ (YES), the second input token x_{skip(i,k)} may be determined based on the first input token xᵢ and the first attention module output vᵢ in operation S130. For example, the second input token x_{skip(i,k)} may be determined as the first input token xᵢ, determined as the first attention module output vᵢ, or determined as a special token related to the first model.

After the second input token x_{skip(i,k)} has been determined, a corresponding second position encoding PE_{(skip(i,k))} may be determined in operation S140. For example, the second position encoding PE_{(skip(I,k)} may be determined via various position embeddings (one dimensional or two dimensional position embedding) based on the position information i of the first input token xᵢ and the number k of times of additional computations. In operation S150, the newly determined second input token x_{skip(i,k)} and second position encoding PE_{(skip(i,k)} may be input to the first model, and a second attention module output may be generated therefrom. In addition, returning to operation S120, it may be determined again whether to additionally perform the first input token, based on the newly generated attention module output.

On the other hand, when it is determined that the additional computation is not performed on the first input token xᵢ (NO), the final output token ŷᵢ may be generated based on the attention module output vᵢ (e.g., the first attention module output when the additional computation is not performed) generated as a result of performing the last additional computation in operation S160. Alternatively, even when it is determined that the additional computation is to be performed on the first input token xᵢ, an output token based on the first attention module output vᵢ may be generated. However, the generated output token may correspond to the invalid output token ŷₛₖᵢₚ.

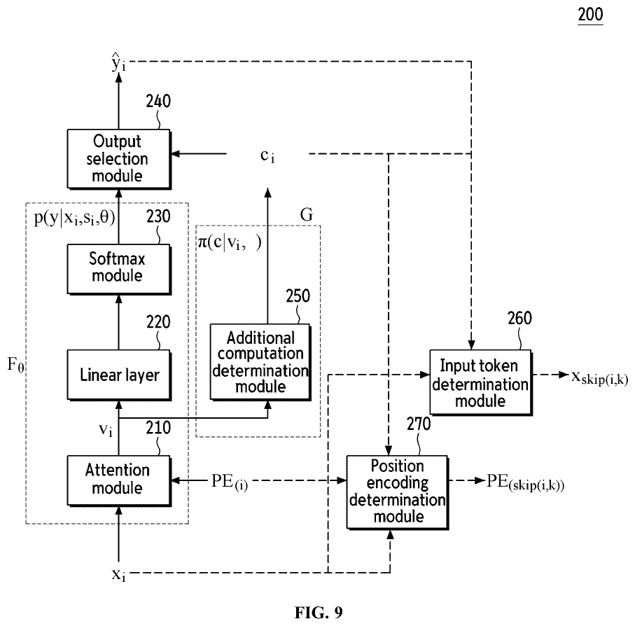

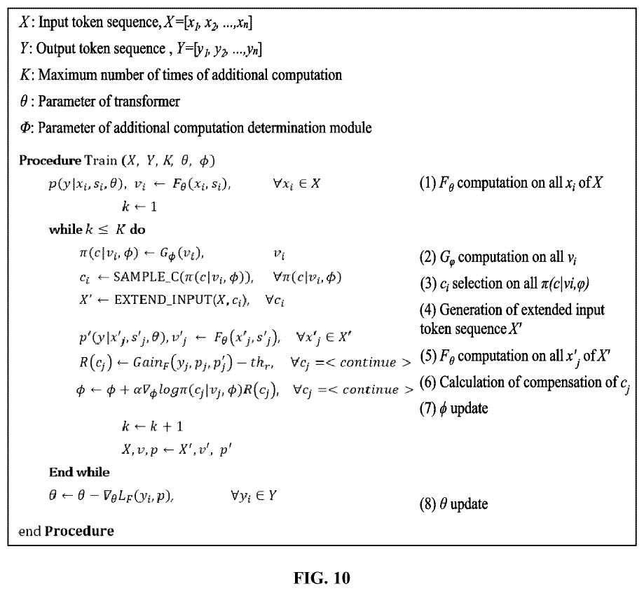

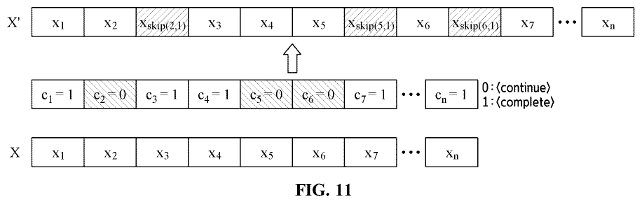

FIG. 9 is a block diagram illustrating a configuration for training of an adaptive transformer 200 according to an embodiment of the present disclosure. For reference, FIG. 9 is a diagram for helping understanding of a training operation of an adaptive transformer to be described later with reference to FIGS. 10 and 11. The configuration and operation of the adaptive transformer 200 are the same as the configuration and operation of the adaptive transformer 100a as described with reference to FIG. 2, and redundant descriptions will be omitted.

Referring to FIG. 9, the computation of the attention module 210, the linear layer 220, and the softmax module 230 except for the output selection module 240 may be expressed as one artificial intelligence model F_{θ} having a parameter θ. In addition, the additional computation determination module 250 may be expressed as an artificial intelligence model Gφ having a parameter φ.

Specifically, the model Fθ may receive the input token xᵢ and sᵢ indicating a hidden state (i.e., a key and a value of a token input before the input token xᵢ) of the attention module 210 to generate the attention module output vᵢ, and may output the softmax probability distribution p(y|xᵢ,sᵢ,θ) through the linear layer 220 and the softmax module 230. That is, a relationship such as F_{θ}(xᵢ, sᵢ)=p(y|xᵢ, sᵢ,θ) may be established.

Next, the model Gφ may receive the attention module output vᵢ from the attention module 210, and may output a probability distribution π(c|vᵢ, φ) indicating whether an additional computation is to be performed on the input token xᵢ. When the distinction between not performing an additional computation on the input token xᵢ (complete) and continuously performing an additional computation (continue) is cᵢ, it may be expressed as c={<complete>, <continue>}, ci∈c. That is, a relationship such as Gφ(vᵢ)=π(c|vᵢ, φ) may be established.

The training of the adaptive transformer 200 may include both training of the artificial intelligence model F_{θ} and training of Gφ. When only the artificial intelligence model F_{θ} exists, the numbers of computations on the input tokens are equal to each other. Thus, it is possible to learn the parameter θ via one parallel computation. However, when the numbers of computations respectively on the input tokens by the artificial intelligence model Gφ corresponding to the additional computation determination module 250 are different from each other, it is impossible to learn both the parameters θ and φ via one parallel computation. This is because when an additional computation is performed on a specific input token, an invalid output token ŷₛₖᵢₚ and an input token x_{skip(i,k)} used for the additional computation should be considered.

To this end, a method for training the adaptive transformer according to an embodiment of the present disclosure includes a method of updating a parameter θ using supervised learning and updating a parameter φ using reinforcement learning. This will be described later with reference to FIGS. 10 to 11.

FIG. 10 is an example code for training of an adaptive transformer according to an embodiment of the present disclosure. Referring to FIG. 10, a computation of the model F_{θ} may be performed on all input tokens xᵢ of an input token sequence X, and the attention module output vi may be generated. Then, all output vᵢ are input to the model Gφ, such that π(c|vᵢ, φ) may be calculated.

Thereafter, on all calculated π(c|vᵢ, φ), cᵢ may be determined (i.e., whether <complete> or <continue>). For example, the cᵢ may be determined using an exploration-utilization strategy among reinforcement learning strategies. When the determination of whether to perform an additional computation is being performed again on the input token on which the additional computation has already been performed (that is, when the value of k is 2 or greater), <continue> may be selected again only at the position at which <continue> has been determined in a previous step, and <continue> is not selected at the position at which <complete> has been determined in a previous step.

When the value of the determined cᵢ is <continue>, an extended input token sequence X′ in which a new input token x_{skip(i,k)} to be subjected to an additional computation is added behind a corresponding input token xᵢ of the input token sequence X may be generated. The input token sequence X and the extended input token sequence X′ will be compared with each other and described with reference to FIG. 11.

FIG. 11 shows an example of each of the input token sequence X and the extended input token sequence X′ of FIG. 10. Referring to FIG. 11, the input token sequence X may include input tokens x₁, x₂, . . . , xₙ, and the additional computation is determined to be performed on x₂, x₅, x₆ among the input tokens. In accordance with this determination, c₂, c₅, and c₆ are determined as <continue>(0), and the remaining c₁, c₃, c₄, c₇, . . . , and cₙ are determined as <complete>(1). Accordingly, the extended input token sequence X′ in which the x_{skip(2,1),} the x_{skip(5,1),} and the x_{skip(6,1)} are respectively added behind the input tokens x₂, x₅, and x₆ on which the additional computation is determined to be performed may be generated. In one example, in a future training process, whether to perform an additional computation only on the input tokens x₂, x₅, and x₆ may be determined, and whether to perform an additional computation on the remaining input tokens may not be determined.

Returning again to FIG. 10, the computation of the model F_{θ} may be performed on all input tokens x′j of the extended input token sequence X′. Next, the gain Gain_{F}(yj, pj, p′j) by the additional computation may be calculated. The gain by the additional computation may be calculated using a difference between a correct answer probability pj(yj) according to the computation of the model F_{θ} before the additional computation and a correct answer probability p′j(yj) according to the computation of the model F_{θ} after the additional computation.

In some embodiments, the gain Gain_{F}(yj, pj, p′j) by the additional computation may be calculated as a difference p′j(yj)-pj(yj) between the two probabilities. In some further embodiments, the gain Gain_{F}(yj, pj, p′j) by the additional computation may be calculated as a ratio p′j(yj)/pj(yj) of the two probabilities. The compensation R(cj) of the model Gφ may be calculated using the difference between the calculated gain Gain_{F}(yj, pj, p′j) and a preset threshold value thᵣ. In this regard, the threshold value thᵣ may correspond to a minimum gain expected via the additional computation.

The parameter φ of the model Gφ may be trained such that an additional computation on the input token is performed when the gain is equal to or greater than the threshold value thᵣ. The parameter φ of the model Gφ may be trained such that an additional computation on the input token is not performed when the gain is smaller than the threshold value thᵣ. The compensation R(cj) of the model Gφ may be used as a compensation for training the parameter φ using the reinforcement learning.

Thereafter, the parameter φ of the model Gφ may be updated using the reinforcement learning algorithm using the previously calculated π(c|vᵢ, φ)and the compensation R(cj). For example, the reinforcement learning algorithm used for updating the parameter φ may include at least one of REINFORCE, actor-critical, Professional Policy Optimization (PPO), or Policy Optimization with Multiple Optima (REINFORCE with shared-baseline). At the same time, the parameter θ may be updated via the calculation of the loss function of the model F_{θ} using p′(y|x′j, s′j, θ). In this regard, the loss on the invalid output may be excluded in the update process.

In some embodiments, the parameters θ and ϕ may be trained based on the randomly determined parameters θ and ϕ. In some further embodiments, the parameter θ may be pre-trained, and the parameters θ and ϕ may be trained based on the pre-trained parameter θ. In some still further embodiments, the parameter θ may be pre-trained, and the parameter ϕ may also be pre-trained using a feature (e.g., a maximum value or entropy of the probability distribution) of the probability distribution of the model F_{θ} based on the pre-trained parameter θ. In addition, the parameters θ and ϕ may be trained based on the pre-trained parameters θ and ϕ.

According to embodiments described with reference to FIGS. 10 to 11, the parameter of the adaptive transformer and the parameter of the additional computation determination module may be simultaneously trained in a form in which supervised learning and reinforcement learning are mixed with each other. That is, according to an embodiment of the disclosure, the efficiency of training the artificial intelligence model may be improved by additionally training the parameter of the additional computation determination module while maintaining the training of the parameters of the transformer in a parallel manner.

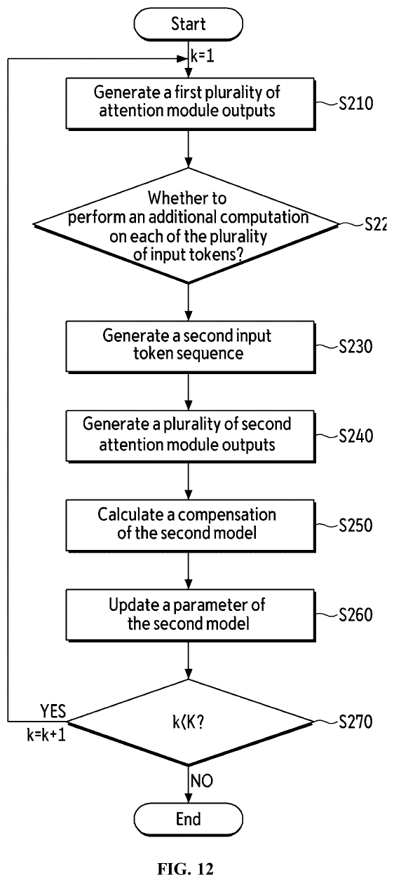

FIG. 12 is an example flowchart illustrating a method for training an adaptive transformer according to an embodiment of the present disclosure. For example, operations S210 to S260 as illustrated in FIG. 12 may be repeated as many times as the maximum number k of times of additional computations (corresponding to K of FIG. 10) determined by the additional computation determination module 250.

In operation S210, a first input token sequence X including a plurality of input tokens may be input to the first model F_{θ}, and a first plurality of attention module outputs corresponding to the plurality of input tokens may be generated therefrom. In operation S220, the first plurality of attention module outputs may be input to the second model Gφ, and whether to perform an additional computation on each of the plurality of input tokens may be determined therefrom.

In operation S230, when it is determined that an additional computation is to be performed on the first input token xᵢ among the plurality of input tokens (cᵢ=<continue>), the second input token x_{skip(i,k)} may be added behind the first input token xᵢ to generate the second input token sequence X′. In operation S240, the second input token sequence X′ may be input to the first model F_{θ}, and a second plurality of attention module outputs corresponding to the plurality of input tokens and the second input tokens x_{skip(i,k)} may be generated therefrom.

In operation S250, a compensation of the second model Gφ may be calculated based on the determination that an additional computation is to be performed on the first input token xᵢ. Specifically, the compensation of the second model Gφ may be calculated as a difference between the gain Gain_{F}(yj,pj,p′j) resulting from the determination to perform the additional computation on the first input token xi and a preset threshold value.

For example, the gain Gain_{F}(yj,pj,p′j) resulting from determination to perform the additional computation may be calculated as a difference p′j(yj)-pj(yj) between a first probability corresponding to a final output token generated based on the first plurality of attention module outputs and a second probability corresponding to a final output token generated based on the second plurality of attention module outputs. Alternatively, the gain resulting from determination to perform the additional computation may be calculated as a ratio p′j(yj)/pj(yj) of the second probability to the first probability.

In operation S260, the parameter of the second model Gφ may be updated based on the determination result of whether to perform the additional computation and the compensation. Thereafter, in operation S270, it may be determined whether operations S210 to S260 are performed as many times as the maximum number K of times of the additional computations. When the additional computation is not performed as many times as the maximum number K of times of the additional computations (that is, k<K; where an initial value of k may be determined to be 1), the process may return to operation S210 (k=k+1). On the other hand, when the operations S210 to S260 are performed as many times as the maximum number K of times of the additional computations, the operations as illustrated in FIG. 12 may be terminated.

FIG. 13 is a block diagram illustrating a hardware configuration of a computing device 500 including an adaptive transformer according to an embodiment of the disclosure.

Referring to FIG. 13, the computing device 500 may include one or more processors 510, a bus 530, a communication interface 540, a memory 520 for loading a computer program executed by the processor 510 therein, and storage 550 for storing therein the computer program 560. However, FIG. 13 shows only components related to an embodiment of the present disclosure. Accordingly, a person skilled in the art to which the present disclosure belongs may appreciate that the computing device 500 may further include other general-purpose components in addition to the components shown in FIG. 13. That is, various components may be further included in the computing device 500 in addition to the components illustrated in FIG. 13. Further, in some cases, the computing device 500 may be configured in a form in which some of the components illustrated in FIG. 13 are omitted. Hereinafter, each of the components of the computing device 500 will be described.

The processor 510 may control an operation of each of the components of the computing device 500. The processor 510 may include at least one of a central processing unit (CPU), a micro processor unit (MPU), a micro controller unit (MCU), a graphic processing unit (GPU), or any type of processor well known in the technical field of the present disclosure. In addition, the processor 510 may perform a computation on at least one application or program for executing an operation/method according to embodiments of the present disclosure. The computing device 500 may include one or more processors.

Next, the memory 520 may store various data, commands and/or information therein. The memory 520 may load therein the computer program 560 from the storage 550 to execute an operation/method according to embodiments of the present disclosure. The memory 520 may be embodied as a volatile memory such as RAM. However, the present disclosure is not limited thereto.

Next, the bus 530 may provide a communication function between the components of the computing device 500. The bus 530 may be embodied as various types of buses such as an address bus, a data bus, and a control bus.

Next, the communication interface 540 may support wired/wireless Internet communication of the computing device 500. Further, the communication interface 540 may support various communication schemes other than Internet communication. To this end, the communication interface 540 may be configured to include a communication module well known in the technical field of the present disclosure.

Next, the storage 550 may non-temporarily store therein one or more computer programs 560. The storage 550 may include a non-volatile memory, such as a read only memory (ROM), an erasable programmable ROM (EPROM), an electrically erasable programmable ROM (EEPROM), a flash memory, a hard disk, a removable disk, or any type of computer-readable recording medium well known in the art to which the present disclosure pertains.

Next, the computer program 560 may include one or more instructions that cause the processor 510 to perform an operation/method according to various embodiments of the disclosure when being loaded into the memory 520. That is, the processor 510 may perform an operation/method according to various embodiments of the disclosure by executing one or more loaded instructions.

For example, the computer program 560 may include instructions for inputting a first input token and a first position encoding corresponding to the first input token to a first model to generate a first attention module output; determining whether to perform an additional computation on the first input token, based on the first attention module output; upon determination that the additional computation is to be performed on the first input token, determining a second input token based on the first input token and the first attention module output; determining a second position encoding corresponding to the second input token; inputting the second input token and the second position encoding to the first model to generate a second attention module output; and upon determination that the additional computation is not to be performed on the first input token, generating a final output token based on the first attention module output.

In addition, the computer program 560 may include instructions for inputting a first input token sequence including a plurality of input tokens to a first model to generate a first plurality of attention module outputs corresponding to the plurality of input tokens; inputting the plurality of first attention module outputs to a second model to determine whether to perform an additional computation on each of the plurality of input tokens; upon determination that an additional computation is to be performed on a first input token among the plurality of input tokens, adding a second input token behind the first input token to generate a second input token sequence; inputting the second input token sequence to the first model to generate a plurality of second attention module outputs corresponding to the plurality of input tokens and the second input token; calculating a compensation of the second model resulting from the determination that the additional computation is to be performed on the first input token; and updating a parameter of the second model, based on a result of determining whether to perform the additional computation and the compensation.

According to an embodiment of the disclosure, instead of performing a fixed amount of the computation on all input tokens of an artificial intelligence model such as a large language model, a variable amount of the computation may be performed on the input token. That is, according to an embodiment of the disclosure, when only a small amount of computations is required for determining an output, only a small amount of computations may be performed. When a large amount of computations is required for determining an output, a large amount of computations may be performed. Accordingly, the amount of computation of the artificial intelligence model may be optimized, and the accuracy of the output of the artificial intelligence model may be improved. In addition, according to an embodiment of the present disclosure, the inference having high accuracy may be achieved at a lower cost in a service using an artificial intelligence model, thereby contributing to enhancing the competitiveness and improving the performance of the service.

Various embodiments and the effects thereof according to the present disclosure have been mentioned with reference to FIGS. 1 through 13. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A method for operating an adaptive transformer, the method being performed by a computing device, the method comprising:
inputting a first input token and a first position encoding corresponding to the first input token to a first model to generate a first attention module output;
determining whether to perform an additional computation on the first input token, based on the first attention module output;
upon determination that the additional computation is to be performed on the first input token, determining a second input token based on the first input token and the first attention module output;
determining a second position encoding corresponding to the second input token;
inputting the second input token and the second position encoding to the first model to generate a second attention module output; and
upon determination that the additional computation is not to be performed on the first input token, generating a final output token based on the first attention module output.

2. The method of claim 1, wherein the determining of whether to perform the additional computation includes:
inputting the first attention module output to a second model to determine whether to perform the additional computation on the first input token,
wherein the second model is an artificial neural network model trained using reinforcement learning (RL).

3. The method of claim 1, wherein the determining of whether to perform the additional computation includes:
calculating a softmax probability distribution corresponding to the first attention module output; and
based on that a maximum value of the softmax probability distribution is smaller than or equal to a predetermined threshold value, determining that the additional computation is to be performed on the first input token.

4. The method of claim 1, wherein the determining of whether to perform the additional computation includes:
calculating a softmax probability distribution corresponding to the first attention module output; and
based on that an entropy of the softmax probability distribution is equal to or greater than a predetermined threshold value, determining that the additional computation is to be performed on the first input token.

5. The method of claim 1, wherein the determining of whether to perform the additional computation includes:
calculating a confidence score corresponding to the first attention module output; and
based on that the confidence score is smaller than or equal to a preset threshold value, determining that the additional computation is to be performed on the first input token.

6. The method of claim 1, wherein the determining of the second input token includes determining the first input token as the second input token.

7. The method of claim 1, wherein the determining of the second input token includes determining the first attention module output as the second input token.

8. The method of claim 1, wherein the determining of the second input token includes determining a special token related to the first model as the second input token.

9. The method of claim 8, wherein the determining of the second input token further includes determining a trainable parameter related to the special token as the second input token.

10. The method of claim 1, wherein the determining of the second input token includes determining a sum of at least two of the first input token, the first attention module output, and a special token related to the first model as the second input token.

11. The method of claim 1, wherein the determining of the second position encoding includes:
determining the second position encoding via one-dimensional position embedding based on position information of the first input token and a number of times the additional computation is performed on the first input token.

12. The method of claim 1, wherein the determining of the second position encoding includes:
determining the second position encoding via two-dimensional position embedding based on a two-dimensional vector having, as components thereof, position information of the first input token and a number of times the additional computation is performed on the first input token.

13. The method of claim 1, wherein the determining of the second position encoding includes:
determining the second position encoding via a first one-dimensional position embedding based on position information of the first input token, and a second one-dimensional position embedding based on a number of times the additional computation is performed on the first input token.

14. A method for training an adaptive transformer, the method being performed by a computing device, the method comprising:
inputting a first input token sequence including a plurality of input tokens to a first model to generate a first plurality of attention module outputs corresponding to the plurality of input tokens;
inputting the plurality of first attention module outputs to a second model to determine whether to perform an additional computation on each of the plurality of input tokens;
upon determination that an additional computation is to be performed on a first input token among the plurality of input tokens, adding a second input token behind the first input token to generate a second input token sequence;
inputting the second input token sequence to the first model to generate a plurality of second attention module outputs corresponding to the plurality of input tokens and the second input token;
calculating a compensation of the second model resulting from the determination that the additional computation is to be performed on the first input token; and
updating a parameter of the second model, based on a result of determining whether to perform the additional computation and the compensation.

15. The method of claim 14, wherein the calculating of the compensation of the second model includes:
calculating, as the compensation of the second model, a difference between a gain resulting from the determination that the additional computation is to be performed on the first input token and a preset threshold value.

16. The method of claim 15, wherein the gain is calculated as a difference between a first probability corresponding to a final output token generated based on the first plurality of attention module outputs and a second probability corresponding to a final output token generated based on the second plurality of attention module outputs.

17. The method of claim 15, wherein the gain is calculated as a ratio of a second probability corresponding to a final output token generated based on the second plurality of attention module outputs to a first probability corresponding to a final output token generated based on the first plurality of attention module outputs.

18. A computing device comprising:
a processor; and
a memory for storing therein instructions,
wherein when the instructions are executed by the processor, the instructions cause the processor to:
input a first input token and a first position encoding corresponding to the first input token to a first model to generate a first attention module output;
determine whether to perform an additional computation on the first input token, based on the first attention module output;
upon determination that the additional computation is to be performed on the first input token, determine a second input token based on the first input token and the first attention module output;
determine a second position encoding corresponding to the second input token;
input the second input token and the second position encoding to the first model to generate a second attention module output; and
upon determination that the additional computation is not to be performed on the first input token, generate a final output token based on the first attention module output.

19. The computing device of claim 18, wherein the determining of whether to perform the additional computation includes:
inputting the first attention module output to a second model to determine whether to perform the additional computation on the first input token,
wherein the second model is an artificial neural network model trained using reinforcement learning (RL).

20. A computing device comprising:
a processor; and
a memory for storing therein instructions,
wherein when the instructions are executed by the processor, the instructions cause the processor to:
input a first input token sequence including a plurality of input tokens to a first model to generate a first plurality of attention module outputs corresponding to the plurality of input tokens;
input the plurality of first attention module outputs to a second model to determine whether to perform an additional computation on each of the plurality of input tokens;
upon determination that an additional computation is to be performed on a first input token among the plurality of input tokens, add a second input token behind the first input token to generate a second input token sequence;
input the second input token sequence to the first model to generate a plurality of second attention module outputs corresponding to the plurality of input tokens and the second input token;
calculate a compensation of the second model resulting from the determination that the additional computation is to be performed on the first input token; and
update a parameter of the second model, based on a result of determining whether to perform the additional computation and the compensation.
